(19) United States
(12) Patent Application Publication
(10) Pub. No.: US 2016/0165923 A1
(43) Pub. Date: Jun. 16, 2016

(54) SOY PROTEIN PRODUCT WITH NEUTRAL OR NEAR NEUTRAL PH ("S701N2")

(71) Applicant: BURCON NUTRASCIENCE (MB) CORP., Winnipeg (CA)

(72) Inventors: Brent E. Green, Warren (CA); Martin Schweizer, Winnipeg (CA); Kevin I. Segall, Winnipeg (CA)

(73) Assignee: BURCON NUTRASCIENCE (MB) CORP., Winnipeg (CA)

(21) Appl. No.: 15/052,135

(22) Filed: Feb. 24, 2016

Related U.S. Application Data
(63) Continuation-in-part of application No. 13/924,860, filed on Jun. 24, 2013, now abandoned.
(60) Provisional application No. 61/663,645, filed on Jun. 25, 2012.

(51) Int. Cl. A23J 1/14; A21D 2/26

(52) U.S. Cl. CPC A23J 1/14; A23L 1/31436; A21D 2/266; A23V 2002/00

(57) ABSTRACT

An aqueous solution of a soy protein product having a protein content of at least about 60 wt % (N×6.25) d.b. which is completely soluble in aqueous media at a pH of less than about 4.4 and heat stable at that pH range is adjusted in pH to a pH of about 6.1 to about 8. The resulting product is further processed by drying the product, recovering and drying any precipitated soy protein material, heat treating and then drying the product, or heat treating the product and recovering and drying any precipitated soy protein material.

### REFERENCE TO RELATED APPLICATION

This application is a continuation-in-part application of co-pending U.S. patent application Ser. No. 13/924,860 filed Jun. 24, 2013, which claims priority under 35 USC 119(e) from U.S. Provisional Patent Application No. 61/663,645 filed Jun. 25, 2012, the disclosures of all of which are hereby incorporated by reference in their entirety.

### FIELD OF THE INVENTION

This invention relates to the provision of soy protein products, preferably isolates, with a neutral or near neutral pH.

### BACKGROUND TO THE INVENTION

In U.S. patent application Ser. No. 12/603,087 filed Oct. 21, 2009 (US Patent Publication No. 2010-0098818, now U.S. Pat. No. 8,691,318), Ser. No. 12/923,897 (7865-454) filed Oct. 13, 2010 (US Patent Publication No. 2011-0038993, now U.S. Pat. No. 8,563,071) and Ser. No. 12/998,422 filed Jun. 1, 2011 (US Patent Publication No. 2011-0236556, now abandoned) (“S701”), assigned to the assignee hereof and the disclosures of which are incorporated herein by reference, there is described the preparation of a soy protein product, preferably a soy protein isolate, which is completely soluble and is capable of providing transparent and heat-stable solutions at low pH values. This protein product may be used for protein fortification of, in particular, soft drinks and sport drinks, as well as other acidic aqueous systems, without precipitation of protein. The soy protein product is produced by extracting a soy protein source with aqueous calcium chloride solution at natural pH, optionally diluting the resulting aqueous soy protein solution, adjusting the pH of the aqueous soy protein solution to a pH of about 1.5 to about 4.4, preferably about 2.0 to about 4.0, to produce an acidified clear soy protein solution, which may be optionally concentrated and diafiltered prior to drying.

### SUMMARY OF INVENTION

In accordance with the present invention, the acidified clear aqueous solution resulting from the process of the aforementioned U.S. patent application Ser. Nos. 12/603,087, 12/923,897 and 12/998,422, is pH adjusted to a pH of about 6.1 to about 8.0, preferably about 6.5 to about 7.5, and either the resulting product is dried or any precipitate which forms is separated and dried. Alternatively, following pH adjustment to a pH of about 6.1 to about 8, the pH adjusted solution may be heat treated and then the resulting product is dried or any precipitate which forms is separated and dried. The acidified clear aqueous solution may be optionally concentrated and optionally diafiltered prior to or following the pH adjustment step.

Alternatively, the dried product from the process of the aforementioned U.S. patent application Ser. Nos. 12/603,087, 12/923,897 and 12/998,422 may be solubilized and the resulting clear aqueous solution is pH adjusted to a pH of about 6.1 to about 8.0, preferably about 6.5 to about 7.5 and either the pH adjusted solution is dried or any precipitate which forms is separated and dried. Alternatively, following pH adjustment to a pH of about 6.1 to about 8, the pH adjusted solution may be heat treated and then the resulting product is dried or any precipitate which forms is separated and dried.

The heat treatment of the pH-adjusted solution generally is effected at a temperature of about 70° to about 160° C. for about 2 seconds to about 60 minutes, preferably about 80° to about 120° C. for about 15 seconds to about 15 minutes, more preferably about 85° to about 95° C. for about 1 to about 5 minutes.

Providing the soy protein product with a natural pH of about 6.1 to about 8.0 facilitates the use of the product in applications having neutral or near neutral pH, eliminating the need to include in the application formulation, pH elevating ingredients to counteract the low pH of the soy protein product. The soy protein products presented herein have a clean flavour and are useful in food applications under neutral or near neutral conditions.

Accordingly, in an aspect of the present invention, there is provided a soy protein product having a protein content of at least about 60 wt % (N×6.25) d.b. with a natural pH in aqueous solution of about 6.1 to about 8 and which has a non-beany flavour.

Accordingly, in another aspect of the present invention, there is provided a soy protein product having a protein content of at least about 60 wt % (N×6.25) d.b. with a natural pH in aqueous solution of about 6.1 to about 8 and which has a non-beany flavor and has a phytic acid content of less than about 1.5 wt %.

In an embodiment of the present invention, the soy protein product has a phytic acid content of less than about 0.5 wt %.

In an embodiment of the present invention, the soy protein product has a natural pH in aqueous solution of about 6.5 to about 7.5.

In an embodiment of the present invention, the soy protein product has a protein content of at least about 90 wt % (N×6.25).

In an embodiment of the present invention, the soy protein product has a protein content of at least about 100 wt % (N×6.25).

In an another embodiment of the present invention, there is provided a soy protein product having a protein content of at least about 60 wt % (N×6.25) d.b., having a molecular weight profile, as determined by the method described in Example 13, which is about 10 to about 46% greater than about 100,000 Da; about 21 to about 34% from about 15,000 to about 100,000 Da; about 1 to about 14% from about 5,000 to about 15,000 Da; and about 20 to about 52% from about 1,000 to about 5,000 Da.

In an embodiment of the present invention, the soy protein product has a molecular weight profile which is about 15 to about 41% greater than about 100,000 Da; about 26 to about 32% from about 15,000 to about 100,000 Da; about 6 to about 9% from about 5,000 to about 15,000 Da; and about 25 to about 47% from about 1,000 to about 5,000 Da.

In another embodiment of the present invention, there is provided a soy protein product having a protein content of at least about 60 wt % (N×6.25) d.b., and a natural pH in aqueous solution of about 6.1 to about 8.0, having a surface hydrophobicity, as determined by the method described in Example 14, which is about 250 to about 575.

Accordingly, in another aspect of the present invention, there is provided a food composition comprising a soy protein product as described above.

In an embodiment of the present invention, the food composition is a processed meat product.

In an embodiment of the present invention, the food composition is a baked good.

In an embodiment of the present invention, the food composition is a nutrition bar.

In an embodiment of the present invention, the food composition is a dairy analogue or alternative product.

In an embodiment of the present invention, the dairy analogue or alternative product is a beverage or a frozen dessert.

Accordingly, in another aspect of the present invention, there is provided a method of producing a soy protein product, which comprises:
(a) providing an aqueous solution of a soy protein product having a protein content of at least about 60 wt % (N×6.25) d.b. which is completely soluble in aqueous media at a pH of less than about 4.4 and heat stable at that pH range,
(b) adjusting the pH of the solution to about pH 6.1 to about 8, preferably about 6.5 to about 7.5, and
(c) optionally drying the entire pH adjusted sample, or
(d) optionally recovering and drying any precipitated soy protein material, or
(e) optionally heat treating the pH-adjusted solution and then drying the entire sample, or
(f) optionally heat treating the pH-adjusted solution then recovering and drying any precipitated soy protein material.

In an embodiment of the present invention, said heat treatment is effected at a temperature of about 70° to about 160° C. for about 2 seconds to about 60 minutes.

In an embodiment of the present invention, said heat treatment is effected at a temperature of about 80° to about 120° C. for about 15 seconds to about 15 minutes.

In an embodiment of the present invention, said heat treatment is effected at a temperature of about 85° to about 95° C. for about 1 to about 5 minutes.

Accordingly, in another aspect of the present invention, the soy protein solution produced according to the procedure of above-noted US Patent Applications may be processed to produce the pH-adjusted soy protein products provided herein. Accordingly, in a further aspect of the present invention, there is provided a method of producing the soy protein product, which comprises:
(a) extracting a soy protein source with an aqueous calcium salt solution, particularly calcium chloride solution, to cause solubilization of soy protein from the protein source and to form an aqueous soy protein solution,
(b) separating the aqueous soy protein solution from residual soy protein source,
(c) optionally diluting the aqueous soy protein solution,
(d) adjusting the pH of the aqueous soy protein solution to a pH of about 1.5 to about 4.4, preferably about 2 to about 4, to produce an acidified aqueous soy protein solution,
(e) optionally heat treating the acidified aqueous soy protein solution to reduce the activity of anti-nutritional trypsin inhibitors and the microbial load,
(f) optionally concentrating the acidified aqueous soy protein solution while maintaining the ionic strength substantially constant by using a selective membrane technique,
(g) optionally diafiltering the optionally concentrated soy protein solution,
(h) optionally pasteurizing the optionally concentrated soy protein solution to reduce the microbial load,
(i) adjusting the pH of the aqueous soy protein solution to about pH 6.1 to about 8, preferably about 6.5 to about 7.5, and
optionally drying the entire pH adjusted sample or
optionally recovering and drying any precipitated soy protein material or
optionally heat treating the pH-adjusted solution and then drying the entire sample or
optionally heat treating the pH-adjusted solution then recovering and drying any precipitated soy protein material.

In an embodiment of the present invention, said heat treatment is effected at a temperature of about 70° to about 160° C. for about 2 seconds to about 60 minutes.

In an embodiment of the present invention, said heat treatment is effected at a temperature of about 80° to about 120° C. for about 15 seconds to about 15 minutes.

In an embodiment of the present invention, said heat treatment is effected at a temperature of about 85° to about 95° C. for about 1 to about 5 minutes.

In an embodiment of the present invention, the pH is adjusted to about 6.5 to about 7.5.

Although a range of soy protein products is available for food use, with a variety of functional properties, and a variety of intended applications, some of the more common applications for commercial soy protein products are processed meat products, baked goods and nutrition bars. The pH adjusted soy protein products of the present invention have a cleaner flavour and lack the characteristic “beany” flavour of conventional soy protein products and can replace the conventional soy protein products in various food products, including the types mentioned above, to provide food products having improved flavour. Preparation of the pH adjusted soy protein products, described below, may incorporate a heat treatment step that serves to modify the functional properties of the protein product, namely lowering the solubility of the protein and increasing the water binding capacity of the material.

The neutral or near neutral soy protein products provided herein are new soy protein products. Accordingly, in another aspect of the invention, there is provided a soy protein product having a protein content of at least about 60 wt %, preferably at least about 90 wt % and more preferably at least about 100 wt %, (N×6.25) d.b. with a natural pH in aqueous solution of about 6.1 to about 8, preferably about 6.5 to about 7.5, and which has a non-beany flavour. The invention further comprises food compositions incorporating such novel soy protein product, including processed meat products, baked goods, nutrition bars and dairy analog or alternative products, such as beverages and frozen desserts.

The soy protein product produced according to the process herein lacks the characteristic beany flavour of soy protein products and is suitable for use in a wide variety of conventional applications of protein products, including but not limited to protein fortification of processed foods and beverages, emulsification of oils, as a body former in baked goods and foaming agent in products which entrap gases. In addition, the soy protein product may be formed into protein fibers, useful in meat analogs and may be used as an egg white substitute or extender in food products where egg white is used as a binder. The soy protein product may also be used in nutritional supplements. The soy protein product may also be used in dairy analog or alternative products or products that are dairy/plant ingredient blends. Other uses of the soy protein product are in pet foods, animal feed and in industrial and cosmetic applications and in personal care products.

### GENERAL DESCRIPTION OF INVENTION

The initial step of the process of providing the soy protein product involves solubilizing soy protein from a soy protein source. The soy protein source may be soybeans or any soy product or by-product derived from the processing of soybeans, including but not limited to soy meal, soy flakes, soy grits and soy flour. The soy protein source may be used in the full fat form, partially defatted form or fully defatted form. Where the soy protein source contains an appreciable amount of fat, an oil-removal step generally is required during the process. The soy protein recovered from the soy protein source may be the protein naturally occurring in soybean or the proteinaceous material may be a protein modified by genetic manipulation but possessing characteristic hydrophobic and polar properties of the natural protein.

Protein solubilization from the soy protein source material is effected most conveniently using calcium chloride solution, although solutions of other calcium salts, may be used. In addition, other alkaline earth metal compounds may be used, such as magnesium salts. Further, extraction of the soy protein from the soy protein source may be effected using calcium salt solution in combination with another salt solution, such as sodium chloride. Additionally, extraction of the soy protein from the soy protein source may be effected using water or other salt solution, such as sodium chloride, with calcium salt subsequently being added to the aqueous soy protein solution produced in the extraction step. Precipitate formed upon addition of the calcium salt is removed prior to subsequent processing.

As the concentration of the calcium salt solution increases, the degree of solubilization of protein from the soy protein source initially increases until a maximum value is achieved. Any subsequent increase in salt concentration does not increase the total protein solubilized. The concentration of calcium salt solution which causes maximum protein solubilization varies depending on the salt concerned. It is usually preferred to utilize a concentration value less than about 1.0 M, and more preferably a value of about 0.10 to about 0.15 M.

In a batch process, the salt solubilization of the protein is effected at a temperature of from about 1° C. to about 100° C., preferably about 15° to about 65° C., more preferably about 50° C. to about 60° C., preferably accompanied by agitation to decrease the solubilization time, which is usually about 1 to about 60 minutes. It is preferred to effect the solubilization to extract substantially as much protein from the soy protein source as is practicable, so as to provide an overall high product yield.

In a continuous process, the extraction of the soy protein from the soy protein source is carried out in any manner consistent with effecting a continuous extraction of soy protein from the soy protein source. In one embodiment, the soy protein source is continuously mixed with the calcium salt solution and the mixture is conveyed through a pipe or conduit having a length and at a flow rate for a residence time sufficient to effect the desired extraction in accordance with the parameters described herein. In such a continuous procedure, the salt solubilization step is effected in a time of about 1 minute to about 60 minutes, preferably to effect solubilization to extract substantially as much protein from the soy protein source as is practicable. The solubilization in the continuous procedure is effected at temperatures between about 1° C. and about 100° C., preferably about 15° to about 65° C., more preferably between about 50° C. and about 60° C.

The extraction is generally conducted at a pH of about 4.5 to about 11, preferably about 5 to about 7. The pH of the extraction system (soy protein source and calcium salt solution) may be adjusted to any desired value within the range of about 4.5 to about 11 for use in the extraction step by the use of any convenient food grade acid, usually hydrochloric acid or phosphoric acid, or food grade alkali, usually sodium hydroxide, as required.

The concentration of soy protein source in the calcium salt solution during the solubilization step may vary widely. Typical concentration values are about 5 to about 15% w/v.

The protein extraction step with the aqueous salt solution has the additional effect of solubilizing fats which may be present in the soy protein source, which then results in the fats being present in the aqueous phase.

The protein solution resulting from the extraction step generally has a protein concentration of about 5 to about 50 g/L, preferably about 10 to about 50 g/L.

The aqueous calcium salt solution may contain an antioxidant. The antioxidant may be any convenient antioxidant, such as sodium sulfite or ascorbic acid. The quantity of antioxidant employed may vary from about 0.01 to about 1 wt % of the solution, preferably about 0.05 wt %. The antioxidant serves to inhibit oxidation of any phenolics in the protein solution.

The aqueous protein solution resulting from the extraction step is then separated from the residual soy protein source, in any convenient manner, such as by employing a decanter centrifuge or any suitable sieve, followed by disc centrifugation and/or filtration, to remove residual soy protein source material. The separation step is typically conducted at the same temperature as the protein solubilization step, but may be conducted at any temperature within the range of about 1° to about 100° C., preferably about 15° to about 65° C., more preferably about 50° to about 60° C. The separated residual soy protein source may be dried for disposal. Alternatively, the separated residual soy protein source may be processed to recover some residual protein. The separated residual soy protein source may be re-extracted with fresh calcium salt solution and the protein solution yielded upon clarification combined with the initial protein solution for further processing as described below. Alternatively, the separated residual soy protein source may be processed by a conventional isoelectric precipitation procedure or any other convenient procedure to recover residual protein.

The aqueous soy protein solution may be treated with an anti-foamer, such as any suitable food-grade, non-silicone based anti-foamer, to reduce the volume of foam formed upon further processing. The quantity of anti-foamer employed is generally greater than about 0.0003% w/v. Alternatively, the anti-foamer, in the quantity described may be added in the extraction steps.

Where the soy protein source contains significant quantities of fat, as described in U.S. Pat. Nos. 5,844,086 and 6,005,076, assigned to the assignee hereof and the disclosures of which are incorporated herein by reference, then the defatting steps described therein may be effected on the separated aqueous protein solution. Alternatively, defatting of the separated aqueous protein solution may be achieved by any other convenient procedure.

The aqueous soy protein solution may be treated with an adsorbent, such as powdered activated carbon or granulated activated carbon, to remove colour and/or odour compounds. Such adsorbent treatment may be carried out under any convenient conditions, generally at the ambient temperature of the separated aqueous protein solution. For powdered activated carbon, an amount of about 0.025% to about 5% w/v, preferably about 0.05% to about 2% w/v, is employed. The adsorbing agent may be removed from the soy solution by any convenient means, such as by filtration.

The resulting aqueous soy protein solution may be diluted generally with about 0.1 to about 10 volumes, preferably about 0.5 to about 2 volumes, of aqueous diluent in order to decrease the conductivity of the aqueous soy protein solution to a value of generally below about 105 mS, preferably about 4 to about 21 mS. Such dilution is usually effected using water, although dilute salt solution, such as sodium chloride or calcium chloride, having a conductivity of up to about 3 mS, may be used.

The diluent with which the soy protein solution is mixed generally has the same temperature as the soy protein solution, but the diluent may have a temperature of about 1° to about 100° C., preferably about 15° to about 65° C., more preferably about 50° to about 60° C.

The optionally diluted soy protein solution then is adjusted in pH to a value of about 1.5 to about 4.4, preferably about 2 to about 4, by the addition of any suitable food grade acid, to result in a clear acidified aqueous soy protein solution. The clear acidified aqueous soy protein solution has a conductivity of generally below about 110 mS for a diluted soy protein solution, or generally below about 115 mS for an undiluted soy protein solution, in both cases preferably about 4 to about 26 mS.

As described in copending U.S. patent application Ser. No. 13/474,788 filed May 18, 2012 (“S704”), assigned to the assignee hereof and the disclosure of which is incorporated herein by reference, the optional dilution and acidification steps may be effected prior to separation of the soy protein solution from the residual soy protein source material.

The clear acidified aqueous soy protein solution may be subjected to a heat treatment to inactivate heat labile anti-nutritional factors, such as trypsin inhibitors, present in such solution as a result of extraction from the soy protein source material during the extraction step. Such a heating step also provides the additional benefit of reducing the microbial load. Generally, the protein solution is heated to a temperature of about 70° to about 160° C., for about 10 seconds to about 60 minutes, preferably about 80° to about 120° C. for about 10 seconds to about 5 minutes, more preferably about 85° to about 95° C., for about 30 seconds to about 5 minutes. The heat treated acidified soy protein solution then may be cooled for further processing as described below, to a temperature of about 2° to about 65° C., preferably about 50° C. to about 60° C.

The optionally diluted, acidified and optionally heat treated protein solution may optionally be polished by any convenient means, such as by filtering, to remove any residual particulates.

The resulting clear acidified aqueous soy protein solution may be adjusted to a pH of about 6.1 to about 8.0, preferably about 6.5 to about 7.5, as described below, optionally further processed as described below and then dried to produce a soy protein product. In order to provide a soy protein product having a decreased impurities content and a reduced salt content, such as a soy protein isolate, the clear acidified aqueous soy protein solution may be processed prior to the pH adjustment step.

The clear acidified aqueous soy protein solution may be concentrated to increase the protein concentration thereof while maintaining the ionic strength thereof substantially constant. Such concentration generally is effected to provide a concentrated soy protein solution having a protein concentration of about 50 to about 300 g/L, preferably about 100 to about 200 g/L.

The concentration step may be effected in any convenient manner consistent with batch or continuous operation, such as by employing any convenient selective membrane technique, such as ultrafiltration or diafiltration, using membranes, such as hollow-fibre membranes or spiral-wound membranes, with a suitable molecular weight cut-off, such as about 3,000 to about 1,000,000 Daltons, preferably about 5,000 to about 100,000 Daltons, having regard to differing membrane materials and configurations, and, for continuous operation, dimensioned to permit the desired degree of concentration as the aqueous protein solution passes through the membranes.

As is well known, ultrafiltration and similar selective membrane techniques permit low molecular weight species to pass therethrough while preventing higher molecular weight species from so doing. The low molecular weight species include not only the ionic species of the food grade salt but also low molecular weight materials extracted from the source material, such as carbohydrates, pigments, low molecular weight proteins and anti-nutritional factors, such as trypsin inhibitors, which are themselves low molecular weight proteins. The molecular weight cut-off of the membrane is usually chosen to ensure retention of a significant proportion of the protein in the solution, while permitting contaminants to pass through having regard to the different membrane materials and configurations.

The concentrated soy protein solution then may be subjected to a diafiltration step using water or a dilute saline solution. The diafiltration solution may be at its natural pH or at a pH equal to that of the protein solution being diafiltered or at any pH value in between. Such diafiltration may be effected using from about 1 to about 40 volumes of diafiltration solution, preferably about 2 to about 25 volumes of diafiltration solution. In the diafiltration operation, further quantities of contaminants are removed from the clear aqueous soy protein solution by passage through the membrane with the permeate. This purifies the clear aqueous protein solution and may also reduce its viscosity. The diafiltration operation may be effected until no significant further quantities of contaminants or visible colour are present in the permeate or until the retentate has been sufficiently purified so as, when pH adjusted, optionally further processed then dried, to provide a soy protein isolate with a protein content of at least about 90 wt % (N×6.25) d.b. Such diafiltration may be effected using the same membrane as for the concentration step. However, if desired, the diafiltration step may be effected using a separate membrane with a different molecular weight cut-off, such as a membrane having a molecular weight cut-off in the range of about 3,000 to about 1,000,000 Daltons, preferably about 5,000 to about 100,000 Daltons, having regard to different membrane materials and configuration.

Alternatively, the diafiltration step may be applied to the clear acidified aqueous protein solution prior to concentration or to partially concentrated clear acidified aqueous protein solution. Diafiltration may also be applied at multiple points during the concentration process. When diafiltration is applied prior to concentration or to the partially concentrated solution, the resulting diafiltered solution may then be additionally concentrated. The viscosity reduction achieved by diafiltering multiple times as the protein solution is concentrated may allow a higher final, fully concentrated protein concentration to be achieved.

The concentration step and the diafiltration step may be effected herein in such a manner that the soy protein product subsequently recovered contains less than about 90 wt % protein (N×6.25) d.b., such as at least about 60 wt % protein (N×6.25) d.b. By partially concentrating and/or partially diafiltering the clear aqueous soy protein solution, it is possible to only partially remove contaminants. This protein solution may then be pH adjusted, optionally further processed as described below and dried to provide a soy protein product with lower levels of purity.

An antioxidant may be present in the diafiltration medium during at least part of the diafiltration step. The antioxidant may be any convenient antioxidant, such as sodium sulfite or ascorbic acid. The quantity of antioxidant employed in the diafiltration medium depends on the materials employed and may vary from about 0.01 to about 1 wt %, preferably about 0.05 wt %. The antioxidant serves to inhibit the oxidation of any phenolics present in the soy protein solution.

The optional concentration step and the optional diafiltration step may be effected at any convenient temperature, generally about 2° to about 65° C., preferably about 50° to about 60° C., and for the period of time to effect the desired degree of concentration and diafiltration. The temperature and other conditions used to some degree depend upon the membrane equipment used to effect the membrane processing, the desired protein concentration of the solution and the efficiency of the removal of contaminants to the permeate.

There are two main trypsin inhibitors in soy, namely the Kunitz inhibitor, which is a heat-labile molecule with a molecular weight of approximately 21,000 Daltons, and the Bowman-Birk inhibitor, a more heat-stable molecule with a molecular weight of about 8,000 Daltons. The level of trypsin inhibitor activity in the final soy protein product can be controlled by manipulation of various process variables.

As noted above, heat treatment of the clear acidified aqueous soy protein solution may be used to inactivate heat-labile trypsin inhibitors. The partially concentrated or fully concentrated aqueous acidified soy protein solution may also be heat treated to inactivate heat labile trypsin inhibitors. When the heat treatment is applied to the partially concentrated acidified soy protein solution, the resulting heat treated solution may then be additionally concentrated.

In addition, the concentration and/or diafiltration steps may be operated in a manner favorable for removal of trypsin inhibitors in the permeate along with the other contaminants. Removal of the trypsin inhibitors is promoted by using a membrane of larger pore size, such as about 30,000 to about 1,000,000 Da, operating the membrane at elevated temperatures, such as about 30° to about 65° C., preferably about 50° to about 60° C. and employing greater volumes of diafiltration medium, such as about 10 to about 40 volumes.

Acidifying and membrane processing the optionally diluted protein solution at a lower pH of about 1.5 to about 3 may reduce the trypsin inhibitor activity relative to processing the solution at higher pH of about 3 to about 4.4.

Further, a reduction in trypsin inhibitor activity may be achieved by exposing soy materials to reducing agents that disrupt or rearrange the disulfide bonds of the inhibitors. Suitable reducing agents include sodium sulfite, cysteine and N-acetylcysteine.

The addition of such reducing agents may be effected at various stages of the overall process. The reducing agent may be added with the soy protein source material in the extraction step, may be added to the clarified aqueous soy protein solution following removal of residual soy protein source material, may be added to the concentrated protein solution before or after diafiltration or may be dry blended with the dried soy protein product. The addition of the reducing agent may be combined with a heat treatment step and the membrane processing steps, as described above.

If it is desired to retain active trypsin inhibitors in the optionally concentrated protein solution, this can be achieved by eliminating or reducing the intensity of the heat treatment step, not utilizing reducing agents, operating the concentration and/or diafiltration steps at the higher end of the pH range, such as pH 3 to about 4.4, utilizing a concentration and/or diafiltration membrane with a smaller pore size, operating the membrane at lower temperatures and employing fewer volumes of diafiltration medium.

The optionally concentrated and optionally diafiltered acidified protein solution may be subject to a further defatting operation, if required, as described in U.S. Pat. Nos. 5,844,086 and 6,005,076. Alternatively, defatting of the optionally concentrated and optionally diafiltered protein solution may be achieved by any other convenient procedure.

The optionally concentrated and optionally diafiltered aqueous protein solution may be treated with an adsorbent, such as powdered activated carbon or granulated activated carbon, to remove colour and/or odour compounds. Such adsorbent treatment may be carried out under any convenient conditions, generally at the ambient temperature of the protein solution. For powdered activated carbon, an amount of about 0.025% to about 5% w/v, preferably about 0.05% to about 2% w/v, is employed. The adsorbent may be removed from the soy protein solution by any convenient means, such as by filtration.

A pasteurization step may be effected on the soy protein solution prior to pH adjustment. Such pasteurization may be effected under nay desired pasteurization conditions. Generally, the optionally concentrated and optionally diafiltered soy protein solution is heated to a temperature of about 55° to about 70° C., preferably about 60° to about 65° C., for about 30 seconds to about 60 minutes, preferably about 10 minutes to about 15 minutes. Alternatively, such pasteurization may be carried out at about 70 to bout 85° C. for about 10 to about 60 seconds. The pasteurized soy protein solution may then be cooled for further processing, preferably to a temperature of about 25° to about 40° C.

A variety of procedures may be used to provide the pH adjusted soy protein product according to the invention from the acid soluble soy protein product and to manipulate the functional properties thereof.

In one such procedure, the acidified aqueous soy protein solution, the partially concentrated soy protein solution or the concentrated soy protein solution described above for the preparation of the acid soluble soy protein product, following optional dilution with about 0.1 to about 6 volumes of water, preferably about 1 to about 4 volumes of water, may be adjusted to a pH about 6.1 to about 8, preferably 6.5 to about 7.5. The entire sample then may be dried or any precipitated solids may be collected by centrifugation and only these dried to form the product. Alternatively, the pH 6.1 to 8 solution may be heated to a temperature of about 70° to about 160° C., for about 2 seconds to about 60 minutes, preferably about 80° to about 120° C., for about 15 seconds to about 15 minutes, more preferably about 85° to about 95° C., for about 1 to about 5 minutes, prior to drying the entire sample or collecting any precipitated solids by centrifugation and drying these to form the product.

As a further alternative, the acidified aqueous soy protein solution may be adjusted in pH to about 6.1 to about 8, preferably about 6.5 to about 7.5 prior to the optional concentration and optional diafiltration steps above. The pH adjusted protein solution resulting from the optional concentration and optional diafiltration steps may then be dried or centrifuged to collect any insoluble soy protein material, which may be dried. Alternatively, the pH adjusted protein solution resulting from the optional concentration and optional diafiltration steps may be heat treated and then dried or centrifuged to collect any insoluble soy protein material, which may be dried.

Alternatively, the clear acidified aqueous soy protein solution, optionally processed as described above, is dried without any pH adjustment. The dried soy protein product then may be redissolved in water and the pH of the resulting clear acidic aqueous solution is raised to a pH of about 6.1 to about 8, preferably 6.5 to about 7.5, in any convenient manner, such as by the use of aqueous sodium hydroxide solution, prior to drying. Alternatively, any precipitate formed on adjustment of the pH to about 6.1 to about 8 is recovered by centrifugation and these solids are dried to yield a soy protein product.

As a further alternative, the pH 6.1 to 8 solution may be heated to a temperature of about 70° C. to about 160° C., for about 2 seconds to about 60 minutes, preferably about 80° to about 120° C., for about 15 seconds to about 15 minutes, more preferably about 85° to about 95° C., for about 1 to about 5 minutes, prior to drying the entire sample, or in yet another alternative procedure, recovering by centrifugation and drying only any insoluble solids present in the heat treated sample.

The dry soy protein product has a protein content of at least about 60 wt % (N×6.25) d.b. Preferably, the dry soy protein product is an isolate with a high protein content, in excess of about 90 wt % protein, preferably at least about 100 wt % protein (N×6.25) d.b.

In the procedures in which precipitated solids are collected and dried, the remaining soluble protein fraction may also be processed to form a soy protein product. The soluble fraction may be dried directly or may be further processed by membrane concentration and/or diafiltration and/or heat treatment prior to drying.

### EXAMPLES

### Example 1

This Example illustrates a procedure for effecting one embodiment of the invention.

30 kg of defatted soy white flakes was combined with 300 L of 0.1 M CaCl₂ solution at 60° C. and agitated for 30 minutes to provide an aqueous protein solution. The bulk of the residual soy flakes were removed and the resulting protein solution was partially clarified by centrifugation with a decanter centrifuge to produce 334.9 L of centrate having a protein content of 3.13% by weight. To this centrate was added 6.7 g antifoam mixed with 93.3 ml water and then the sample was further clarified by centrifugation with a disc stack centrifuge to provide 230 L of centrate having a protein content of 2.86% by weight.

This centrate was then added to 175 L of reverse osmosis purified water at 50° C. and the pH of the sample lowered to 3.43 with HCl that had been diluted 1:1 with water.

The diluted and acidified protein extract solution was reduced in volume from 372 L to 103 L by concentration on a polyethersulfone (PES) membrane, having a molecular weight cutoff of 100,000 Daltons, operated at a temperature of approximately 47° C. The acidified protein solution, with a protein content of 5.10 wt %, was diafiltered with 515 L of reverse osmosis purified water, with the diafiltration operation conducted at approximately 50° C. The resulting diafiltered protein solution was further concentrated to provide a solution with a protein content of 12.24% by weight and then diluted with water to a protein content of 6.45 wt %. An aliquot of this solution was diluted with an equal volume of water and the pH raised to 7.35 with 1 M NaOH solution. The protein content of the pH adjusted solution was 3.14 wt % and this sample represented a yield of 33.4 wt % of the post-disc stack centrate. The pH adjusted protein solution was then dried to yield a product found to have a protein content of 101.01 wt % (N×6.25) d.b. The product was given designation S110729AS-A30-12A S701N2-01.

### Example 2

This Example illustrates a procedure for effecting a further embodiment of the invention.

300 kg of defatted soy white flakes was combined with 3180 L of 0.1 M CaCl₂ solution at 60° C. and agitated for 30 minutes to provide an aqueous protein solution. The bulk of the residual soy flakes were removed and the resulting protein solution was partially clarified by centrifugation with a decanter centrifuge to produce ‘a’ L of centrate having a protein content of ‘b’ % by weight. To this centrate was added 20 g antifoam mixed with 280 ml water and then the sample was further clarified by centrifugation with a disc stack centrifuge to provide ‘c’ L of centrate having a protein content of ‘d’ % by weight.

The centrate was then added to ‘e’ L of reverse osmosis purified water at 60° C. and the pH of the sample lowered to ‘f’ with HCl that had been diluted 1:1 with water.

The diluted and acidified protein extract solution was reduced in volume from ‘g’ L to ‘h’ L by concentration on a polyethersulfone (PES) membrane, having a molecular weight cutoff of 100,000 Daltons, operated at a temperature of approximately ‘i’ ° C. Concurrent with the concentration step, the acidified protein solution was diafiltered with ‘j’ L of reverse osmosis purified water. The resulting diafiltered and concentrated protein solution had a protein content of ‘k’ % by weight. An aliquot of this solution was diluted with RO water and the pH of the sample raised to ‘l’ with NaOH solution. This diluted and pH adjusted protein solution had a protein content of ‘m’ wt % and represented a yield of ‘n’ wt % of the post-disc stack centrate. This protein solution was then dried to yield a product found to have a protein content of ‘o’ wt % (N×6.25) d.b. The product was given designation ‘p’.

The values for the parameters a to p for two runs are provided in the following Table 1:

TABLE 1

| p | S110729AS-B15-12A S701N2-01 | S110729AS-B21-12A S701N2-01 |
|---|---|---|
| a | 3267 | 3286.3 |
| b | 2.86 | 2.80 |
| c | 2388 | 2387.2 |
| d | 2.89 | 2.84 |
| e | 1578 | 1594.3 |
| f | 3.19 | 3.03 |
| g | 3915 | 3981.5 |
| h | 365 | 425 |
| i | 60 | 50 |
| j | 3300 | 5455.5 |
| k | 10.9 | approximately 10.9 |
| 1 | 7.22 | 7.76 |
| m | 3.69 | 3.26 |
| n | 8.0 | not available |
| o | 97.14 | 95.38 |

### Example 3

This Example contains an evaluation of the phytic acid content of the protein products produced as described in Examples 1 and 2. Phytic acid content was determined using the method of Latta and Eskin (J. Agric. Food Chem., 28: 1313-1315).

The results obtained are set forth in the following Table 2.

TABLE 2
Phytic acid content of protein products

| product | % phytic acid d.b. |
|---|---|
| S110729AS-A30-12A S701N2-01 | 0.29 |
| S110729AS-B15-12A S701N2-01 | 0.06 |
| S110729AS-B21-12A S701N2-01 | 0.11 |

As may be seen from the results presented in Table 2, the soy protein products prepared as described in Examples 1 and 2 were very low in phytic acid content.

### Example 4

This Example illustrates the colour of the protein products produced as described in Examples 1 and 2. The colour of the dry powders was assessed using a HunterLab ColorQuest XE instrument operated in reflectance mode.

The results obtained are set forth in the following Table 3.

TABLE 3
HunterLab color readings for protein products

| product | L* | a* | b* |
|---|---|---|---|
| S110729AS-A30-12A S701N2-01 | 87.64 | −0.54 | 6.88 |
| S110729AS-B15-12A S701N2-01 | 87.98 | −0.69 | 8.08 |
| S110729AS-B21-12A S701N2-01 | 87.57 | −1.09 | 8.57 |

As may be seen from the results presented in Table 3, the soy protein products prepared as described in Examples 1 and 2 were light in colour.

### Example 5

This Example illustrates the solubility of the protein products produced as described in Examples 1 and 2. Protein solubility was evaluated using a modified version of the procedure of Morr et al., J. Food Sci. 50:1715-1718.

Sufficient protein powder to supply 0.5 g of protein was weighed into a beaker and then a small amount of reverse osmosis (RO) purified water was added and the mixture stirred until a smooth paste formed. Additional water was then added to bring the volume to approximately 45 ml. The contents of the beaker were then slowly stirred for 60 minutes using a magnetic stirrer. The pH was determined immediately after dispersing the protein and was adjusted to the appropriate level (6, 6.5, 7, 7.5 or 8) with diluted NaOH or HCl. The pH was measured and corrected periodically during the 60 minutes stirring. After the 60 minutes of stirring, the samples were made up to 50 ml total volume with RO water, yielding a 1% protein w/v dispersion. The protein content of the dispersions was measured by combustion analysis using a Leco Nitrogen Determinator. Aliquots of the dispersions were then centrifuged at 7,800 g for 10 minutes which sedimented insoluble material and yielded a supernatant. The protein content of the supernatant was measured by combustion analysis and the protein solubility of the product was then calculated as follows:

Solubility (%)=(% protein in supernatant/% protein in initial dispersion)×100

The solubility values are shown in Table 4.

TABLE 4
Solubility of S701N2 products at different pH values

| | Solubility (%) | | | | |
|---|---|---|---|---|---|
| Product | pH 6 | pH 6.5 | pH 7 | pH 7.5 | pH 8 |
| S110729AS-A30-12A S701N2-01 | 9.9 | 63.1 | 75.9 | 81.5 | 91.2 |
| S110729AS-B15-12A S701-N2-01 | 12.1 | 21.0 | 45.3 | 34.2 | 39.5 |
| S110729AS-B21-12A S701N2-01 | 12.1 | 26.9 | 47.1 | 52.5 | 41.5 |

As may be seen from the results in Table 4, the S701N2 products were not very soluble at pH 6, but were somewhat more soluble at the higher pH values tested.

### Example 6

This Example contains an evaluation of the water binding capacity of the soy protein products produced as described in Examples 1 and 2.

Protein powder (1 g) was weighed into centrifuge tubes (50 ml) of known weight. To this powder was added approximately 20 ml of reverse osmosis purified (RO) water at the natural pH. The contents of the tubes were mixed using a vortex mixer at moderate speed for 1 minute. The samples were incubated at room temperature for 5 minutes then mixed with the vortex mixer for 30 seconds. This was followed by incubation at room temperature for another 5 minutes followed by another 30 seconds of vortex mixing. The samples were then centrifuged at 1,000 g for 15 minutes at 20° C. After centrifugation, the supernatant was carefully poured off, ensuring that all solid material remained in the tube. The centrifuge tube was then re-weighed and the weight of water saturated sample was determined.

Water binding capacity (WBC) was calculated as:

WBC (ml/g)=(mass of water saturated sample−mass of initial sample)/(mass of initial sample×total solids content of sample)

The water binding capacity of the S701N2 products is shown in Table 5.

TABLE 5
Water binding capacity of S701N2 products

| product | Water binding capacity (ml/g) |
|---|---|
| S110729AS-A30-12A S701N2-01 | 2.53 |
| S110729AS-B15-12A S701N2-01 | 7.64 |
| S110729AS-B21-12A S701N2-01 | 7.57 |

As may be seen from the results in Table 5, the S701N2 products tested had moderate water binding capacity.

### Example 7

This Example illustrates the preparation of a soy protein isolate by conventional isoelectric precipitation.

30 kg of soy white flake was added to 300 L of RO water at ambient temperature and the pH adjusted to 8.5 by the addition of 1M sodium hydroxide solution. The sample was agitated for 30 minutes to provide an aqueous protein solution. The pH of the extraction was monitored and maintained at 8.5 throughout the 30 minutes. The residual soy white flake was removed and the resulting protein solution clarified by centrifugation and filtration to produce 278.7 L of filtered protein solution having a protein content of 2.93% by weight. The pH of the protein solution was adjusted to 4.5 by the addition of HCl that had been diluted with an equal volume of water and a precipitate formed. The precipitate was collected by centrifugation then washed by re-suspending it in 2 volumes of RO water. The washed precipitate was then collected by centrifugation. A total of 32.42 kg of washed precipitate was obtained with a protein content of 18.15 wt %. This represented a yield of 72.0% of the protein in the clarified extract solution. An aliquot of 16.64 kg of the washed precipitate was combined with an equal weight of RO water and then the pH of the sample adjusted to 6 with sodium hydroxide. The pH adjusted sample was then spray dried to yield an isolate with a protein content of 93.80% (N×6.25) d.b. The product was designated S013-K19-09A conventional IEP pH 6.

### Example 8

This Example is a sensory evaluation of the S110729AS-A30-12A S701N2-01 product prepared as described in Example 1 and the conventional soy protein isolate product prepared as described in Example 7.

Samples were presented for sensory evaluation as a 2% protein w/v dispersion in purified drinking water. A small amount of food grade sodium hydroxide solution was incorporated when preparing the 5013-K19-09A conventional IEP sample so as to raise the pH of the sample to match that of the S110729AS-A30-12A S701N2-01 sample. Samples were presented blindly to an informal panel of 8 panelists who were asked to identify which sample had more beany flavour and which sample they preferred the flavour of.

Seven out of eight panelists found the 5110729AS-A30-12A S701N2-01 to have less beany flavour and all eight panelists preferred the flavour of the S110729A5-A30-12A S701N2-01.

### Example 9

This Example is a sensory evaluation of the S110729AS-B15-12A S701N2-01 product prepared as described in Example 2 and the conventional soy protein isolate product prepared as described in Example 7.

Samples were presented for sensory evaluation as a 2% protein w/v dispersion in purified drinking water. A small amount of food grade sodium hydroxide solution was incorporated when preparing the 5013-K19-09A conventional IEP sample so as to raise the pH of the sample to match that of the S110729AS-B15-12A S701N2-01 sample. Samples were presented blindly to an informal panel of 8 panelists who were asked to identify which sample had more beany flavour and which sample they preferred the flavour of.

Seven out of eight panelists found the S110729AS-B15-12A S701N2-01 to have less beany flavour and five out of eight panelists preferred the flavour of the S110729AS-B15-12A S701N2-01.

### Example 10

This Example is a sensory evaluation of the 5110729AS-B21-12A S701N2-01 prepared as described in Example 2 and the conventional soy protein isolate product prepared as described in Example 7.

Samples were presented for sensory evaluation as a 2% protein w/v dispersion in purified drinking water. A small amount of food grade sodium hydroxide solution was incorporated when preparing the S013-K19-09A conventional IEP sample so as to raise the pH of the sample to match that of the S110729AS-B21-12A S701N2-01 sample. Samples were presented blindly to an informal panel of 7 panelists who were asked to identify which sample had more beany flavour and which sample they preferred the flavour of.

Five out of seven panelists found the 5110729AS-B21-12A S701N2-01 to have less beany flavour and four out of seven panelists preferred the flavour of the 5110729AS-B21-12A S701N2-01.

### Example 11

This Example additionally illustrates preparation of the product of the present invention.

‘a’ kg of defatted soy white flakes was combined with ‘b’ L of ‘c’ M CaCl₂ solution at about 60° C. and agitated for 30 minutes to provide an aqueous protein solution. The bulk of the residual soy flakes were removed and the resulting protein solution was partially clarified by centrifugation with a decanter centrifuge to produce ‘d’ L of centrate having a protein content of ‘e’ % by weight. To this centrate was added ‘f’ g antifoam and then the sample was further clarified by centrifugation with a disc stack centrifuge to provide ‘g’ L of centrate having a protein content of ‘h’ % by weight.

This centrate was then added to ‘i’ L of reverse osmosis purified water at 50° C. and the pH of the sample lowered to ‘j’ with HCl that had been diluted 1:1 with water.

The diluted and acidified protein extract solution was reduced in volume from ‘k’ L to ‘l’ L by concentration on a polyethersulfone (PES) membrane, having a molecular weight cutoff of 100,000 daltons, operated at a temperature of about ‘m’° C. The acidified protein solution, with a protein content of ‘n’ wt %, was diafiltered with ‘o’ L of reverse osmosis purified water, with the diafiltration operation conducted at about ‘p’° C. The resulting diafiltered protein solution was further concentrated to provide a solution with a protein content of ‘q’ % by weight. The concentrated protein solution was adjusted to a pH of about ‘r’ with KOH/NaOH solution then diluted with water ‘s’. ‘t’ of pH adjusted solution, having a pH of ‘u’, protein content of ‘v’ wt % and representing a yield of ‘w’ wt % of the post-disc stack centrate was spray dried to yield a product found to have a protein content of ‘x’ wt % (N×6.25) d.b. The product was given designation ‘y’.

The values for the parameters a to y for three runs are provided in the following Table 6.

TABLE 6

| | S024-J31-13A | S024-K13-13A | S024-K25-13A |
|---|---|---|---|
| y | S701N2 | S701N2 | S701N2 |
| a | 100 | 76 | 80 |
| b | 1000 | 760 | 800 |
| c | 0.09 | 0.09 | 0.10 |
| d | not recorded | not recorded | not recorded |
| e | 2.99 | 2.81 | 3.09 |
| f | 3 | 2 | 2 |
| g | 784 | 590 | 591 |
| h | 2.90 | 2.72 | 2.95 |
| i | 510 | 365 | 371 |
| j | 2.92 | 3.14 | 3.21 |
| k | 1280 | 945 | 962 |
| 1 | 380 | 260 | 275 |
| m | 51 | 52 | 50 |
| n | 5.26 | 5.78 | 5.65 |
| o | 570 | 780 | 825 |
| p | 51 | 51 | 51 |
| q | 10.75 | 11.87 | 11.00 |
| r | 7 | 7.3 | 7.3 |
| s | not applicable | not applicable | and then the pH |
| | | | corrected to about 7.3 |
| t | 50.94 kg | 90 L | 69.12 kg |
| u | 6.98 | 7.54 | 7.40 |
| v | 3.56 | 5.50 | 4.98 |
| w | 8.0 | 30.8 | 19.7 |
| x | 95.51 | 97.38 | 98.39 |

### Example 12

This Example contains an evaluation of the phytic acid content of the protein products produced as described in Example 11. Phytic acid content was determined using the method of Latta and Eskin (J. Agric. Food Chem., 28: 1313-1315).

The results obtained are set forth in the following Table 7.

TABLE 7
Phytic acid content of protein products

| product | % phytic acid d.b. |
|---|---|
| S024-J31-13A S701N2 | 0.00 |
| S024-K13-13A S701N2 | 0.08 |
| S024-K25-13A S701N2 | 0.00 |

As may be seen from the results presented in Table 7, the soy protein products prepared as described in Example 11 were very low in phytic acid content.

### Example 13

This Example illustrates the molecular weight profile of the soy protein products prepared as described in Examples 1, 2 and 11 as well as the molecular weight profile of the commercial soy protein products Pro Fam 825 and Pro Fam 875 (both ADM, Decatur, Ill.).

Molecular weight profiles were determined by size exclusion chromatography using a Varian ProStar HPLC system equipped with a 300×7.8 mm Phenomenex BioSep S-2000 series column. The column contained hydrophilic bonded silica rigid support media, 5 micron diameter, with 145 Angstrom pore size.

Before the soy protein samples were analyzed, a standard curve was prepared using a Biorad protein standard (Biorad product #151-1901) containing proteins with known molecular weights between 17,000 daltons (myoglobulin) and 670,000 daltons (thyroglobulin) with Vitamin B12 added as a low molecular weight marker at 1,350 daltons. A 0.9% w/v solution of the protein standard was prepared in water, filtered with a 0.45 μm pore size filter disc then a 50 μL aliquot run on the column using a mobile phase of 0.05M phosphate/0.15 M NaCl, pH 6 containing 0.02% sodium azide. The mobile phase flow rate was 1 mL/min and components were detected based on absorbance at 280 nm. Based on the retention times of these molecules of known molecular weight, a regression formula was developed relating the natural log of the molecular weight to the retention time in minutes.

Retention time (min)=−0.865×ln(molecular weight)+17.154(r²=0.98)

For the analysis of the soy protein samples, 0.05M phosphate/0.15 M NaCl, pH 6 containing 0.02% sodium azide was used as the mobile phase and also to dissolve dry samples. Protein samples were mixed with mobile phase solution to a concentration of 1% w/v, placed on a shaker for at least 1 hour then filtered using 0.45 μm pore size filter discs. Sample injection size was 50 μL. The mobile phase flow rate was 1 mL/minute and components were detected based on absorbance at 280 nm.

The above regression formula relating molecular weight and retention time was used to calculate retention times that corresponded to molecular weights of 100,000 Da, 15,000 Da, 5,000 Da and 1,000 Da. The HPLC ProStar system was used to calculate the peak areas lying within these retention time ranges and the percentage of protein ((range peak area/total protein peak area)×100) falling in a given molecular weight range was calculated. Note that the data was not corrected by protein response factor.

The molecular weight profiles of the products prepared as described in Examples 1, 2, 11 and the commercial products are shown in Table 8.

TABLE 8
Molecular weight profile of pulse protein products

| | | % 15,000- | % 5,000- | % 1,000- |
|---|---|---|---|---|
| product | % > 100,000 Da | 100,000 Da | 15,000 Da | 5,000 Da |
| S110729AS-A30-12A S701N2-01 | 40.7 | 26.1 | 7.4 | 25.8 |
| S110729AS-B15-12A S701N2-01 | 15.6 | 30.3 | 8.0 | 46.2 |
| S110729AS-B21-12A S701N2-01 | 24.6 | 30.5 | 7.9 | 36.9 |
| S024-J31-13A S701N2 | 24.4 | 27.6 | 8.5 | 39.5 |
| S024-K13-13A S701N2 | 19.8 | 29.7 | 8.3 | 42.3 |
| S024-K25-13A S701N2 | 23.0 | 31.6 | 6.1 | 39.3 |
| Pro Fam 825 | 36.2 | 30.8 | 17.3 | 15.6 |
| Pro Fam 875 | 26.3 | 30.1 | 21.5 | 22.0 |

As may be seen from the results presented in Table 8, the molecular weight profiles of the products prepared according to Examples 1, 2 and 11 were different from the molecular weight profiles of the commercial soy protein products.

### Example 14

This Example describes the determination of the surface hydrophobicity of the soy protein products prepared as described in Examples 1 and 11 and the commercial soy protein products Pro Fam 825 and Pro Fam 875. Surface hydrophobicity was assessed using a modified version of the method of Wu et al., 1998, J.A.O.C.S., 75:845-850.

Small aliquots (about 15 mg) of protein product were weighed out and combined with pH 7 phosphate buffer (1 ml) by vortex mixing. The samples were then further diluted by mixing 1:100 with pH 7 phosphate buffer. A series of additional dilutions (up to fourfold) was then performed with additional pH 7 phosphate buffer. Three or four samples of different concentrations were then analyzed for each protein product.

To each of these samples (2 ml) was added a 20 μl aliquot of ANS solution and the samples mixed on a shaker. The samples were then transferred to a quartz cell and analyzed for Fluoresence Intensity on a Jasco FP-6300 Spectrofluorimeter set to 390-nm excitation and 470-nm emissivity and blanked with the pH 7 phosphate buffer.

The surface hydrophobicity S₀ was calculated as the slope of the linear regression of the FI (Fluorescence Intensity) value versus the protein concentration in w/v (mg/mL).

The surface hydrophobicity values determined for the products prepared as described in Examples 1 and 11 and the commercial soy protein products Pro Fam 825 and Pro Fam 875 are shown in Table 9.

TABLE 9
Surface hydrophobicity values for soy protein products

| product | surface hydrophobicity |
|---|---|
| S110729AS-A30-12A S701N2-01 | 530 |
| S024-J31-13A S701N2 | 295 |
| S024-K13-13A S701N2 | 369 |
| Pro Fam 825 | 788 |
| Pro Fam 875 | 693 |

As may be seen from the results presented in Table 9, the surface hydrophobicity of the S701N2 products was lower than that of the commercial soy protein isolates.

### SUMMARY OF THE DISCLOSURE

In summary of this disclosure, the present invention provides soy protein products which have a neutral or near neutral pH. Modifications are possible within the scope of the invention.

What we claim is:

1. A soy protein product having a protein content of at least about 60 wt % (N×6.25) d.b. with a natural pH in aqueous solution of about 6.1 to about 8 and which has a non-beany flavor and has a phytic acid content of less than about 1.5 wt %.

2. The soy protein product of claim 1, having a phytic acid content of less than about 0.5 wt %.

3. The soy protein product of claim 1 with a natural pH in aqueous solution of about 6.5 to about 7.5.

4. The soy protein product of claim 1 which has a protein content of at least about 90 wt % (N×6.25).

5. The soy protein product of claim 4 which has a protein content of at least about 100 wt % (N×6.25).

6. A soy protein product having a protein content of at least about 60 wt % (N×6.25) d.b., having a molecular weight profile, as determined by the method described in Example 13, which is
about 10 to about 46% greater than about 100,000 Da;
about 21 to about 34% from about 15,000 to about 100,000 Da;
about 1 to about 14% from about 5,000 to about 15,000 Da; and
about 20 to about 52% from about 1,000 to about 5,000 Da.

7. The soy protein product of claim 6, having a molecular weight profile which is
about 15 to about 41% greater than about 100,000 Da;
about 26 to about 32% from about 15,000 to about 100,000 Da;
about 6 to about 9% from about 5,000 to about 15,000 Da; and
about 25 to about 47% from about 1,000 to about 5,000 Da.

8. A soy protein product having a protein content of at least about 60 wt % (N×6.25) d.b., and a natural pH in aqueous solution of about 6.1 to about 8.0, having a surface hydrophobicity between about 250 and about 575 as determined by the method described in Example 14.

9. A food composition comprising a soy protein product as claimed in claim 1, 6 or 8.

10. The food composition of claim 9 which is a processed meat product.

11. The food composition of claim 9 which is a baked good.

12. The food composition of claim 9 which is a nutrition bar.

13. The food composition of claim 9 which is a dairy analogue or alternative product.

14. The food composition of claim 13 wherein the dairy analogue or alternative product is a beverage or a frozen dessert.

15. A method of producing a soy protein product, which comprises:
providing an aqueous solution of a soy protein product having a protein content of at least about 60 wt % (N×6.25) d.b. which is completely soluble in aqueous media at a pH of less than about 4.4 and heat stable at that pH range,
adjusting the pH of the solution to about pH 6.1 to about 8, and
optionally drying the entire pH adjusted sample or
optionally recovering and drying any precipitated material or
optionally heat treating the pH-adjusted solution and then drying the entire sample or
optionally heat treating the pH-adjusted solution then recovering and drying any precipitated material.

16. The method of claim 15 wherein said heat treatment is effected at a temperature of about 70° to about 160° C. for about 2 seconds to about 60 minutes.

17. The method of claim 16 wherein said heat treatment is effected at a temperature of about 80° to about 120° C. for about 15 seconds to about 15 minutes.

18. The method of claim 17 wherein said heat treatment is effected at a temperature of about 85° to about 95° C. for about 1 to about 5 minutes.

19. A method of producing a soy protein product, which comprises:
(a) extracting a soy protein source with an aqueous calcium salt solution, particularly calcium chloride solution, to cause solubilization of soy protein from the protein source and to form an aqueous soy protein solution,
(b) separating the aqueous soy protein solution from residual soy protein source,
(c) optionally diluting the aqueous soy protein solution,
(d) adjusting the pH of the aqueous soy protein solution to a pH of about 1.5 to about 4.4, preferably about 2 to about 4, to produce an acidified clear soy protein solution,
(e) optionally heat treating the acidified solution to reduce the activity of anti-nutritional trypsin inhibitors and the microbial load,
(f) optionally concentrating the aqueous clear soy protein solution while maintaining the ionic strength substantially constant by using a selective membrane technique,
(g) optionally diafiltering the optionally concentrated soy protein solution,
(h) optionally pasteurizing the optionally concentrated soy protein solution to reduce the microbial load,
(i) adjusting the pH of the aqueous soy protein solution to about pH 6.1 to about 8, and
optionally drying the entire pH adjusted sample or
optionally recovering and drying any precipitated material or
optionally heat treating the pH-adjusted solution and then drying the entire sample or
optionally heat treating the pH-adjusted solution then recovering and drying any precipitated material.

20. The method of claim 19 wherein said heat treatment is effected at a temperature of about 70° to about 160° C. for about 2 seconds to about 60 minutes.

21. The method of claim 20 wherein said heat treatment is effected at a temperature of about 80° to about 120° C. for about 15 seconds to about 15 minutes.

22. The method of claim 21 wherein said heat treatment is effected at a temperature of about 85° to about 95° C. for about 1 to about 5 minutes.

23. The method of claim 15 wherein the pH is adjusted to about 6.5 to about 7.5.

24. The method of claim 19, wherein the pH is adjusted to about 6.5 to about 7.5.
